(19) United States
(12) Patent Application Publication
(10) Pub. No.: US 2008/0165099 A1
(43) Pub. Date: Jul. 10, 2008

(54) LCDS AND METHODS FOR DRIVING SAME

(76) Inventors: Heung Su CHO, Asan-si (KR); Kyung Yul Kim, Yeonje-gu (KR); Kyung Hun Lee, Masan-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/969,624

(22) Filed: Jan. 4, 2008

(30) Foreign Application Priority Data
Jan. 4, 2007 (KR) 10-2007-0001008

(51) Int. Cl. G09G 3/36

(52) U.S. Cl. 345/87

(57) ABSTRACT

A liquid crystal display (LCD) and method for driving it that removes residual images from the display during power-off include an LCD panel that displays an image, a power-off residual image removal unit that detects a power-off state using pixel data and a driving voltage supplied from a main body through an interface and generates a residual image removal signal for a liquid crystal arrangement of the panel made when a voltage is not applied thereto, and a data driver outputting the residual image removal signal to remove a residual image from the LCD panel.

### RELATED APPLICATIONS

This application claims priority to Korean Patent Application No. 10-2007-0001008, filed Jan. 4, 2007, the entire disclosure of which is incorporated herein by reference.

### BACKGROUND

This disclosure relates to liquid crystal displays (LCDs), and more particularly, to methods for driving LCDs such that residual images of the LCDs are removed during power-off.

With the development of the information society, LCDs have received increased attention for use as display devices. Cathode ray tube (CRT) display devices that were widely used heretofore have some advantages in terms of product performance and costs; however, they also have certain well-known disadvantages in terms of miniaturization and portability. Thus, although LCD display devices are typically somewhat more expensive than their CRT display counterparts, their application range has been greatly extended due to their recognized advantages of being light in weight, slim in size, and low in power consumption.

LCDs display a desired image by applying an electric field to a layer of a liquid crystal material having dielectric anisotropy that is disposed between two substrates of the display, and then adjusting the intensity of the electric field to control the light transmittance therethrough. When a device incorporating an LCD, such as a computer or a flat screen TV display, is powered off, the LCD itself is typically turned off in the sequential order of a backlight assembly supplying light to an LCD panel of the display, then pixel data and a plurality of synchronization signals converted into low-voltage differential signaling (LVDS) signals, and finally, a driving voltage. As a result, undesirable residual images may be produced on the LCD panel when the power is turned off, thereby causing a perceived deterioration in the quality of the display.

### BRIEF SUMMARY

In accordance with the exemplary embodiments disclosed herein, LCDs and methods for driving them are provided in which residual images in the LCD panels of the displays are removed during display power-off.

In one exemplary embodiment, an LCD includes an LCD panel displaying an image, a power-off residual image removal unit detecting a power-off state using pixel data and a driving voltage supplied from a main body through an interface and generating a residual image removal signal for a liquid crystal arrangement made when a voltage is not applied thereto, and a data driver outputting the residual image removal signal to remove a residual image of the LCD panel.

The interface may use a low-voltage differential signaling (LVDS) mode. The power-off residual image removal unit may include a power-off detector that detects the power-off state of the main body using the pixel data and the driving voltage, and a residual image removal signal generator that generates the residual image removal signal in accordance with the power-off state detected by the power-off detector.

The power-off detector may include a bipolar transistor functioning as a switch. The bipolar transistor includes an NPN transistor and a PNP transistor. The power-off detector may include a metal oxide semiconductor (MOS) transistor functioning as a switch. A liquid crystal operating mode of the LCD may be either a normally white mode or a normally black mode.

In another exemplary embodiment, a method for driving an LCD includes detecting a power-on or power-off state, generating a high or low detecting signal in accordance with the power-on or power-off state using pixel data and a driving voltage supplied from a main body through an interface, generating a residual image removal signal for a liquid crystal arrangement made when a voltage is not applied thereto, supplying the residual image removal signal to a data driver, and supplying the residual image removal signal to an LCD panel to remove a residual image therefrom.

The pixel data and the driving voltage may be transmitted in a low-voltage differential signaling (LVDS) mode. The detecting of the power-off state may use a bipolar transistor functioning as a switch to detect the power-off state. The detecting of the power-off state may comprise using a metal oxide semiconductor (MOS) transistor functioning as a switch to detect the power-off state. state. A liquid crystal operating mode of the LCD may be either a normally white mode or a normally black mode.

A better understanding of the above and many other features and advantages of this invention may be obtained from a consideration of the detailed description thereof below, particularly if such consideration is made in conjunction with the several views of the appended drawings, wherein like elements are referred to by like reference numerals throughout.

### BRIEF DESCRIPTION OF THE DRAWINGS

FIG. 1 is a functional block diagram of an exemplary embodiment of an LCD and main body device in accordance with the present invention;

FIG. 2 is a diagram illustrating the sequential order in which a backlight assembly, an LVDS signal and a driving voltage of the exemplary LCD are turned off when the LCD is powered off;

FIG. 3 is a circuit diagram of an exemplary embodiment of a power-off detector of an exemplary embodiment of a power-off residual image removal unit of the exemplary LCD of FIG. 1;

FIG. 4 is a circuit diagram of an alternative exemplary embodiment of power-off detector of the exemplary power-off residual image removal unit of the exemplary LCD of FIG. 1;

FIG. 5 is a flowchart illustrating a preferred exemplary embodiment of a method for driving an LCD in accordance with the present invention;

FIG. 6 is a schematic perspective view of an exemplary LCD panel sequentially displaying a white gray scale signal in an embodiment in which the liquid crystal mode of operation of the panel is a normally white mode; and,

FIG. 7 is a schematic perspective view of an exemplary LCD panel sequentially displaying a black gray scale signal in an embodiment in which the liquid crystal mode of operation of the panel is a normally black mode.

### DETAILED DESCRIPTION

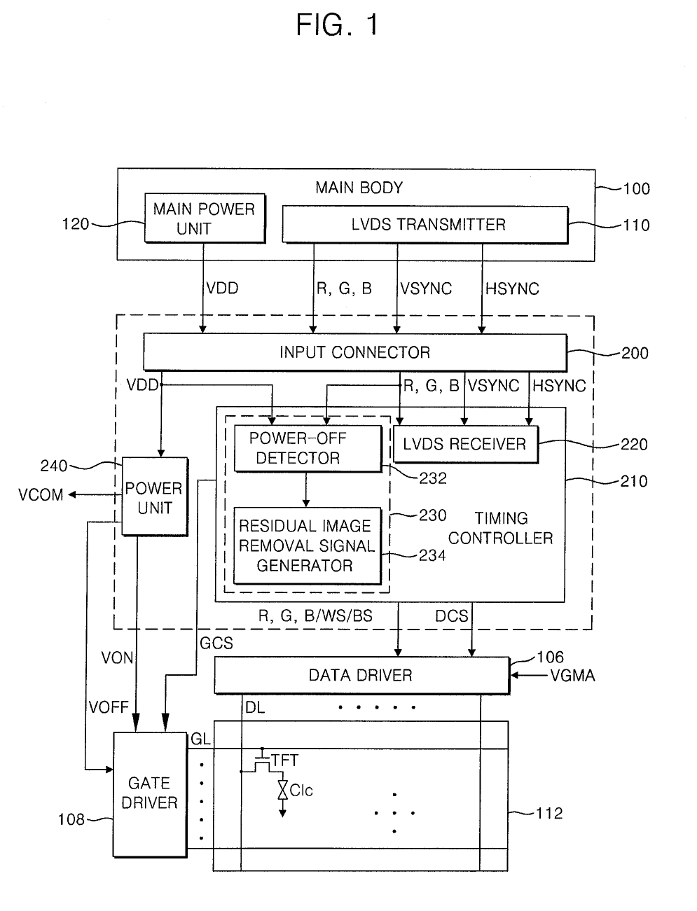

FIG. 1 is a functional block diagram of an exemplary embodiment of an LCD and associated main body device 100 in accordance with the present invention. The exemplary LCD includes an input connector 200, a timing controller 210, a power unit 240, a gate driver 108, a data driver 106, and an LCD panel 112 having a pixel matrix. The input connector 200 supplies pixel data RGB and a plurality of synchronization signals VSYNC and HSYNC, supplied from a low-voltage differential signaling (LVDS) transmitter 110 of the main body 100, to the timing controller 210. The timing controller 210 controls the driving timings of the gate driver 108 and the data driver 106. The power unit 240 supplies a gate-on voltage VON, a gate-off voltage VOFF, and a common voltage VCOM required for driving the LCD device. The gate driver 108 drives gate lines GL of the LCD panel 112 and the data driver 106 drives data lines DL of the LCD panel 112.

The LVDS transmitter 110 supplies the pixel data RGB, the horizontal synchronization signal HSYNC, the vertical synchronization signal VSYNC and a driving voltage VDD, supplied from the main body 100, to the input connector 200. The LVDS transmitter 110 digitalizes and compresses the pixel data RGB, the horizontal synchronization signal HSYNC and the vertical synchronization signal VSYNC, converts the same into LVDS signals, and supplies the LVDS signals to the input connector 200.

The input connector 200 receives the pixel data RGB, the horizontal synchronization signal HSYNC, the vertical synchronization signal VSYNC, and the driving voltage VDD and supplies the same to an LVDS receiver 220 of the timing controller 210. Moreover, the input connector 200 supplies the driving voltage VDD, applied from a main power unit 120 of the main body 100, to the power unit 240. Additionally, the input connector 200 also supplies the driving voltage VDD and any one of the pixel data RGB to a power-off residual image removal unit 230 of the timing controller 210, as described in more detail below.

The driving voltage VDD supplied from the input connector 200 to the power unit 240 and the timing controller 210 is then supplied by these elements to the data driver 106 and the gate driver 108 as a digital driving voltage. In particular, the power unit 240 generates a gate-on voltage VON and a gate-off voltage VOFF using the driving voltage VDD from the input connector 200 and supplies the same to the gate driver 108, and additionally, generates a common voltage and supplies the same to the LCD panel 112.

The timing controller 210 generates a plurality of control signals GCS, DCS, RGB, WS and BS for controlling the driving timings of the gate driver 108 and the data driver 106 using the vertical synchronization signal VSYNC, the horizontal synchronization signal HSYNC and the pixel data RGB input from the input connector 200.

More specifically, the timing controller 210 restores the pixel data RGB and the plurality of synchronization signals HSYNC and VSYNC from the input connector 200 converted into LVDS signals to reduce electromagnetic interference (EMI). For example, the LVDS receiver 220 restores the pixel data RGB and the plurality of synchronization signals HSYNC and VSYNC using a voltage difference between the LVDS signals input from the input connector 200.

The timing controller 210 generates data control signals DCS controlling the data driver 106 and gate control signals GCS controlling the gate driver 108 using the restored pixel data RGB and the plurality of synchronization signals HSYNC and VSYNC and outputs the same to the gate driver 108 and the data driver 106.

The data control signals DCS generated by the timing controller 210 include a source start pulse SSP, a source shift clock SSC, a polarity control signal POL, and a source output enable signal SOE. The gate control signals GCS include a gate start pulse GSP, a gate shift clock GSC, and a gate output enable signal GOE.

Moreover, the timing controller 210 rearranges the pixel data RGB supplied from the input connector 200 appropriate to the display and provides the rearranged data to the data driver 106.

When the main body 100 is powered off, the power-off residual image removal unit 230 of the timing controller 210 generates a residual image removal signal for a liquid crystal arrangement made when the voltage is not applied thereto and supplies the same to the data driver 106, in the manner described in more detail below.

The possible liquid crystal operational modes of the LCD include either a “normally white” mode or a “normally black” mode. In the normally white mode, the device exhibits the highest liquid crystal transmittance, i.e., “white,” when no voltage is being applied to the liquid crystal material contained therein, and as the voltage applied thereto begins to increase, the liquid crystal transmittance decreases proportionately. Conversely, in the normally black mode, the device exhibits the lowest liquid crystal transmittance, i.e., “black,” when no voltage is being applied to the liquid crystal material, and as the voltage applied thereto begins to increase, the liquid crystal transmittance increases proportionately. Accordingly, in the normally white mode, the residual image removal signal corresponds to a white gray scale signal, whereas, in the normally black mode, the residual image removal signal corresponds to a black gray scale signal.

In the particular exemplary embodiment illustrated in FIG. 1, the timing controller 210 includes the power-off residual image removal unit 230 mentioned above for removing residual images from the LCD during power-off of the device using the pixel data RGB and the driving voltage VDD supplied from the input connector 200. The power-off residual image removal unit 230 includes a power-off detector 232 that detects power-on/off states of the main body 100, and a residual image removal signal generator 234 that generates the residual image removal signal according to the on/off states detected by the power-off detector 232. When a user turns off the main body 100 of the device, the LCD itself is turned off in the sequential order of 1) a backlight assembly (B/L) (not illustrated), 2) the pixel data RGB and the plurality of synchronization signals HSYNC and VSYNC converted into LVDS signals, and 3) the driving voltage VDD. Accordingly, when the power is off, the power-off residual image removal unit 230 supplies either a white gray scan signal WS or a black gray scale signal BS, as may be appropriate, to the data driver 106 using the pixel data RGB and the plurality of synchronization signals HSYNC and VSYNC converted into LVDS signals during a specific delay time T.

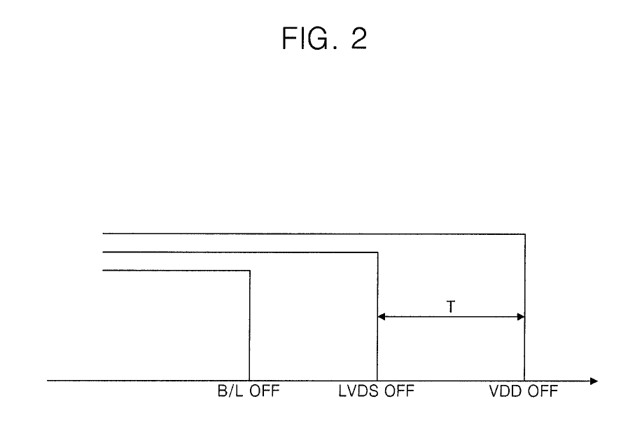

As a result, as illustrated in FIG. 2, at the moment the main body 100 is turned off, the residual image displayed on the LCD panel 112 is removed after the delay time T, which extends from the time at which the pixel data RGB and the plurality of synchronization signals HSYNC and VSYNC converted into LVDS signals are turned off, to the time at which the driving voltage VDD is turned off.

The data driver 106 generates a sampling signal by shifting the source start pulse SSP from the timing controller 210 according to the source shift clock SSC. The data driver 106 then latches the pixel data RGB according to the sampling signal and successively supplies the same in response to the source output enable signal SOE. Subsequently, the data driver 106 converts the pixel data RGB into an analog pixel signal based on a gamma voltage VGMA input from a gamma voltage generator (not illustrated), and supplies the same to the data lines DL. In this case, while converting the pixel data into the analog pixel signal, the data driver 106 determines the polarity of the pixel signal in response to the polarity control signal POL from the timing controller 210. Moreover, the data driver 106 determines the period during which the pixel signal is supplied to the data lines DL in response to the source output enable signal SOE. Meanwhile, when the main body 100 is turned off, the data driver 106 supplies the residual image removal signal applied from the power-off residual image removal unit 230 to the LCD panel 112 through the data line DL.

The gate driver 108 shifts the gate start pulse GSP from the timing controller 210 according to the gate shift clock GSC to sequentially supply a scan pulse of the gate-on voltage VON from the power unit 240 to the gate lines GL. At this time, the gate driver 108 supplies the scan pulse of the gate-on voltage VON to the gate lines GL of the LCD panel 112.

The gate driver 108 supplies the gate-off voltage VOFF from the power unit 240 to the gate lines GL during the rest period when the scan pulse of the gate-on voltage VON is not supplied to the gate lines GL. Moreover, the gate driver 108 controls the pulse width of the scan pulse based on the gate output enable signal GOE from the timing controller 210.

The LCD panel 112 includes the gate lines GL, the data lines DL and a pixel matrix including a plurality of sub-pixels. Each of the sub-pixels includes a liquid crystal cell Clc that controls the amount of light transmitted therethrough in accordance with a pixel signal, and a thin film transistor TFT driving the liquid crystal cell Clc. The TFT is turned on when the scan pulse is supplied from the gate line GL so as to apply the pixel signal from the data line DL to the liquid crystal cell Clc. In the liquid crystal cell Clc, the arrangement of the molecules of the liquid crystal material having dielectric anisotropy is changed in accordance with the pixel signal charged through the TFT to control the amount of light transmitted through the pixel, thereby realizing a gray scale display of light.

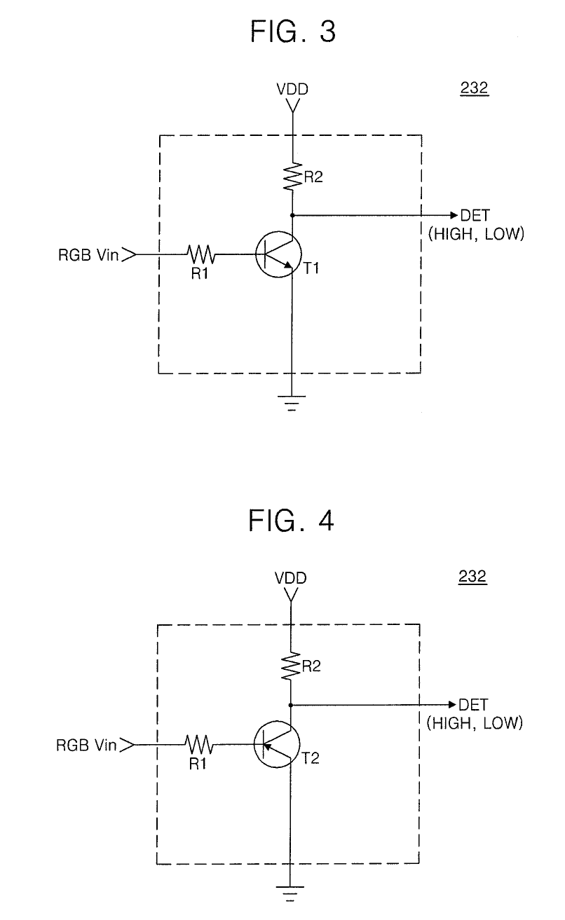

FIG. 3 is a circuit diagram of the exemplary power-off detector 232 of the exemplary power-off residual image removal unit 234 of the exemplary LCD of FIG. 1. As illustrated in FIG. 3, the power-off detector 232 includes an NPN transistor T1 that functions as a switch, a first resistor R1 connected between the NPN transistor T1 and an input terminal RGB Vin, and a second resistor T2 connected to a driving voltage supply terminal VDD and an output terminal DET. Accordingly, if the power-off detector 232 detects the power-on or power-off state of the main body 100 through the input terminal RGB Vin, the transistor T1 functions as a switch to supply a high or low signal HIGH or LOW to the residual image removal signal generator 234 through the output terminal DET. The input terminal RGB Vin is connected to a pixel data supply line supplying the pixel data RGB from the input connector 200 to the LVDS receiver 220. The driving voltage supply terminal VDD is connected to a driving voltage supply line supplying the driving voltage VDD from the input connector 200 to the power unit 240. Moreover, the pixel data RGB from the input terminal 200 can be supplied to the input terminals of the LVDS receiver 220, the power unit 240, and the power-off detector 232 by means of the first resistor R1 without influencing each other.

Alternatively, as illustrated in FIG. 4, a PNP transistor T2 may be used as the transistor included in the power-off detector 232 in accordance with another exemplary embodiment of the present invention. Moreover, a bipolar transistor or a metal oxide semiconductor (MOS) transistor having the same functions may be used.

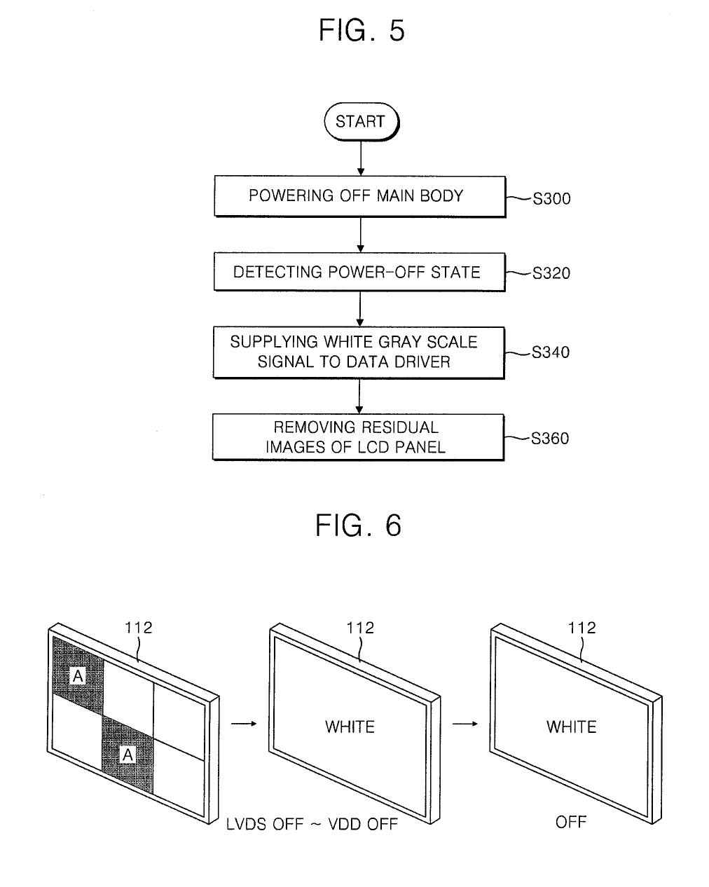

FIG. 5 is a flowchart illustrating a preferred exemplary embodiment of a method for driving an LCD in accordance with the present invention, and FIG. 6 is a schematic perspective view of a normally white LCD panel during a power-off procedure effected using the method of FIG. 5.

Referring to FIG. 5, the exemplary method for driving the LCD includes powering off the main body 100 (S300); detecting, at the power-off detector 232, a power-on or power-off state to generate a high or low detecting signal HIGH or LOW in accordance with the power-on or power-off state, and supplying the high or low detecting signal HIGH or LOW to the residual image removal signal generator 234 (S320); generating, at the residual image removal signal generator 234, a residual image removal signal of white gray scale WS or black gray scale BS in accordance with the high or low detecting signal HIGH or LOW, and supplying the residual image removal signal to the data driver 106 (S340); and, supplying the residual image removal signal to the LCD panel 112 to remove the residual image therefrom (S360).

In more detail, the method of driving the LCD is as follows. First, the user turns off the main body 100 or a laptop computer (S300). Then, the power-off detector 232 detects the power-on or power-off state of the main body 100 through the input connector 200, and supplies the high or low detecting signal HIGH or LOW to the residual image removal signal generator 234 (S320). In particular, if the main body 100 is powered on, the pixel data RGB is supplied to the power-off detector 232 of the power-off residual image removal unit 230, and as a result, the NPN transistor T1, for example, is turned on to supply the low detecting signal LOW to the residual image removal signal generator 234.

On the other hand, if the main body 100 is powered off, no pixel data RGB is supplied to the power-off detector 232 of the power-off residual image removal unit 230, and as a result, the NPN transistor T1, for example, is turned off to supply the high detecting signal HIGH to the residual image removal signal generator 234.

Subsequently, the residual image removal signal generator 234 generates the residual image removal signal in accordance with the high or low detecting signal HIGH or LOW and supplies the residual image removal signal to the data driver 106 (S340).

More specifically, if the low detecting signal LOW is supplied to the residual image removal signal generator 234 through the power-off detector 232, the residual image removal signal generator 234 does not operate. However, if the high detecting signal HIGH is supplied to the residual image removal signal generator 234 through the power-off detector 232, the residual image removal signal generator 234 supplies the residual image removal signal to the data driver 106.

FIG. 6 is a diagram illustrating an LCD panel displaying a white gray scale signal in an embodiment in which the LCD is operating in the normally white mode. As illustrated in FIG. 6, residual images of area ‘A’ displayed on the LCD panel 112 while the main body 100 is powered on are removed as the residual image removal signal is supplied to the data driver 106 during the delay time T between the pixel data and synchronization signal off period LVDS OFF and the driving voltage off period VDD OFF (S360), thus displaying a completely white LCD panel 112, i.e., one with no residual image left thereon.

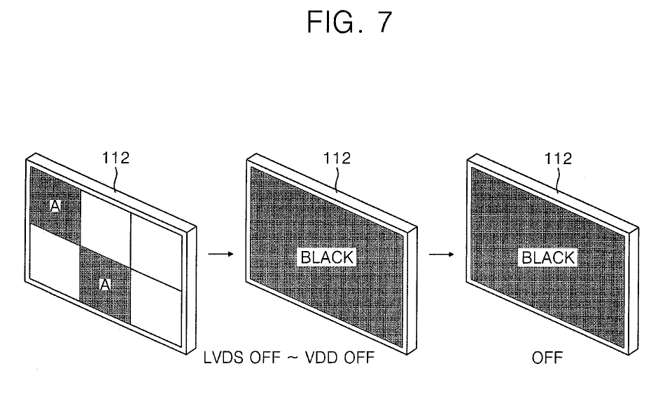

FIG. 7 is a diagram illustrating an LCD panel displaying a black gray scale signal in an embodiment in which the display is operating in the normally black mode, in which the residual image removal signal generator 234 generates a residual image removal signal of the black gray scale signal BS and supplies the same to the data driver 106 to display a completely black LCD panel 112, i.e., one with no residual image left thereon.

As described above, the LCD and method of driving the same in accordance with the present invention include a power-off residual image removal unit for removing residual images of the LCD panel during power-off using the pixel data and the driving voltage. The power-off residual image removal unit generates a residual image removal signal of either a white gray scale or a black gray scale during power-off and supplies the same to the data driver to display either all white or all black on the LCD panel, as appropriate, thereby removing any residual images therefrom.

As will by now be evident to persons of skill in this art, many modifications, substitutions and variations can be made in and to the materials, components, configurations and methods of implementation of the LCDs and methods for driving them of the present invention without departing from its spirit and scope. Accordingly, the scope of the present invention should not be limited to the particular embodiments illustrated and described herein, as they are merely exemplary in nature, but rather, should be fully commensurate with that of the claims appended hereafter and their functional equivalents.

What is claimed is:

1. A liquid crystal display (LCD), comprising:
an LCD panel displaying an image;
a power-off residual image removal unit that detects a power-off state using pixel data and a driving voltage supplied from a main body through an interface and generates a residual image removal signal for a liquid crystal arrangement made when a voltage is not applied thereto; and,
a data driver outputting the residual image removal signal to the LCD panel so as to remove a residual image therefrom.

2. The LCD of claim 1, wherein the interface uses a low-voltage differential signaling (LVDS) mode.

3. The LCD of claim 1, wherein the power-off residual image removal unit comprises:
a power-off detector that detects the power-off state of the main body using the pixel data and the driving voltage; and,
a residual image removal signal generator that generates the residual image removal signal in accordance with the power-off state detected by the power-off detector.

4. The LCD of claim 3, wherein the power-off detector comprises a bipolar transistor functioning as a switch.

5. The LCD of claim 4, wherein the power-off detector comprises a metal oxide semiconductor (MOS) transistor functioning as a switch.

6. The LCD of claim 1, wherein a liquid crystal operating mode of the LCD is a normally white mode or a normally black mode.

7. A method of driving an LCD, the method comprising:
detecting a power-on or a power-off state;
generating a high or low detecting signal in accordance with the power-on or power-off state using pixel data and a driving voltage supplied from a main body through an interface;
generating a residual image removal signal for a liquid crystal arrangement made when a voltage is not applied thereto;
supplying the residual image removal signal to a data driver; and,
supplying the residual image removal signal to an LCD panel so as to remove a residual image therefrom.

8. The method of claim 7, wherein the pixel data and the driving voltage are transmitted in a low-voltage differential signaling (LVDS) mode.

9. The method of claim 7, wherein detecting the power-off state comprises using a bipolar transistor functioning as a switch to detect the power-off state.

10. The method of claim 9, wherein detecting the power-off state comprises using a metal oxide semiconductor (MOS) transistor functioning as a switch to detect the power-off state.

11. The method of claim 7, wherein a liquid crystal operating mode of the LCD is a normally white mode or a normally black mode.
